(19) United States
(12) Patent Application Publication
(10) Pub. No.: US 2003/0004834 A1
(43) Pub. Date: Jan. 2, 2003

(54) Online shopping method, online shopping system and computer program product for realizing the same

(75) Inventor: Katsuhiro Yamazaki, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/183,502

(22) Filed: Jun. 28, 2002

(30) Foreign Application Priority Data
Jun. 28, 2001 (JP) 2001-196326

(51) Int. Cl. G06F 17/60

(52) U.S. Cl. 705/26

(57) ABSTRACT

An authentication unit included in a third-party section, such as an Internet service provider, etc. registering user authentication information and personal information, determines whether a user terminal as a proper user terminal. Only the authenticated user terminal can access a Web server via a repeater. When relaying billing data from the Web server to the user terminal, the billing data is recorded as history data. A settlement unit acts as a collector for collecting a predetermined amount of money to be paid by the user terminal to the Web server, based on the recorded billing data.

### BACKGROUND OF THE INVENTION

1. Field of the Invention

The present invention relates to an online shopping method, and, more particularly, to an online shopping method and its system, wherein a third-party unit collects the amount of money to be paid by a user to a Web shop.

2. Description of the Related Art

In recent years, with the rapid spread of the Internet, the online shopping services can easily be provided from Web shops on the WWW, by accessing each of the Web servers from a personal computer, etc.

Those products (services) purchased through the Web shop can be paid, using a payment method that requires a credit card for payment. In this case, the user informs a Web server about his/her credit-card information at the time of purchasing the products. Then, the Web server issues a bill for the products to a corresponding credit-card company. Upon this, the credit-card company receives a predetermined amount of money billed in the issued bill from the user's bank account.

FIG. 16 shows a typical example of a conventional online shopping system. As shown in FIG. 16, the conventional online shopping system comprises a user terminal 300, an access server 310 of an ISP (Internet Service Provider) that a user of the user terminal 300 is one member, an authentication server 320 of the ISP, and a Web server 350 for providing online shopping services. Authentication information (including a set of a user name (an account name) and a password) of each member of the ISP is registered in the authentication server 320. The Web server 350 is connected to the Internet 390.

In the case where the user uses the online shopping services provided from the Web server 350, through the user terminal 300, the user terminal 300 connects to the access server 310 through dial-up connection, and uses an Internet connection service upon accomplishment of user authentication. In this case, in order to accomplish the user authentication, the user inputs his/her authentication information, and the access server 310 sends the input authentication information to the authentication server 320.

Upon reception of the authentication information from the access server 310, the authentication server 320 determines whether the sent information is valid.

In the case where it is determined that the input authentication information is valid, the access server 310 assigns the user terminal 300 an IP address, thereby enabling the Internet access through the access server 310.

On the contrary, in the case where it is determined that the input authentication information is not valid, the access server 310 sends a message representing that the user terminal 300 can not access the Internet 390, thereby preventing the access from any unauthorized users.

The user who is permitted to use the Internet connection service can directly access the Web server 350 via the Internet 390 from the user terminal 300. The user refers to a Web page provided by the Web server 350, selects a desired product(s) to be purchased through a predetermined Web shop, and sends ordering information including personal information, such as his/her name, address, phone number, etc. and credit-card information necessary for payment settlement, to the Web server 350 via the Internet 390.

Upon reception of such ordering information from the user, the Web server 350 performs a credit search for investigating the credit-card information included in the received ordering information. If there is no problem in the ordering information as a result of the search, the Web server 350 arranges for delivery of product ordered by the user, in accordance with the input personal information, and requests a credit-card company to pay a predetermined amount of money to be paid for the user.

According to such a settlement method using a user credit card, the credit-card information is transmitted over public networks. Hence, the credit-card information may be stolen or accessed by malice or mistake, by someone unauthorized to access a corresponding Web site.

Many users do not feel comfortable about providing their credit-card information onto an unfamiliar Web site. Hence, it is obviously demanded that a new payment method be realized in place of the credit card.

The followings are some payment methods without the need for a credit card.

Unexamined Japanese Patent Application KOKAI Publication No H9-282367 discloses a shopping-mediating system for withdrawing a predetermined amount of money for user-purchased goods from a user's bank account, based on data sent from a shopping mediator for mediating the transaction between customers and a seller.

Unexamined Japanese Patent Application KOKAI Publication No. H9-153964 discloses a method of charging users for information-providing services and a user's bank account as telephone charges, in accordance with telephone calls from the user.

Further, Unexamined Japanese Patent Application KOKAI Publication No. H11-313058 discloses a settlement method of realizing payment settlement between users by a communications company, using a charge collection system for periodically billing subscribers of a communications network for services charges. This method can be adopted for online shopping.

Based on thus disclosed techniques, users need to go through further procedures other than the normal procedures for ordering products, so that it is not convenient for the users to use the above services.

Unexamined Japanese Patent Application KOKAI Publication No. H10-177552 discloses a method of collectively managing, in a proxy server, user authentication information necessary for accessing Web servers, and sending the user authentication information requested by the Web servers from the proxy server. This method is effective for simplifying the authentication procedures for connecting to the Web servers, in the case where different authentication information are required respectively by different Web servers to be accessed by the users.

Even with this method, in the online shopping system, the users need to input their personal information, such as their name, address, phone number, etc. from the user terminal in accordance with a request from the Web servers, and send the input personal information to the Web servers.

### SUMMARY OF THE INVENTION

The present invention has been made in consideration of the above. It is accordingly an object of the present invention to provide an online shopping method and its system for realizing online shopping in accordance with simple procedures without using a credit card.

Another object thereof is to provide an online shopping method and its system for realizing online shopping, even a user need not go through a troublesome procedure for inputting all his/her personal information requested by a Web server.

In order to achieve the above objects, according to the first aspect of the present invention, there is provided an online shopping method comprising:

storing user-authentication information necessary for an authentication section to perform user authentication, the authentication section having a repeater for relaying data between at least one user terminal and a plurality of Web servers;

determining whether a user of the at least one user terminal is a proper user in a case where the at least one user terminal intends to access the authentication unit, and permitting the at least one user terminal to access the plurality of Web servers through the repeater in a case where it is determined that the user of the at least one user terminal is a proper user;

recording billing data, sent from each of the plurality of Web servers in response to an order for a product item from the at least one user terminal, of data to be relayed by the repeater between each of the plurality of Web servers and the at least one user terminal; and

in the authentication section, calculating an amount of money to be paid by the user to each of the plurality of Web servers based on the recorded billing data, and acting as a collector for collecting the calculated amount of money to be paid by the user to each of the plurality of Web servers.

According to this invention, the authentication section, such as an Internet service provider, etc. storing user authentication information determines whether a user is a proper or authorized user. Only those authenticated users can access a plurality of Web servers via a repeater. Billing data sent from the plurality of Web servers to the user address via the repeater is stored as history data The authentication section acts as a collector for collecting a predetermined amount of money to be paid by the at least one user terminal to the plurality of Web servers based on the stored billing data. According to this invention, the users can enjoy online shopping, through easy procedures without using a credit card.

The online shopping method may further comprise, in the authentication section:

storing personal information specifying the user; and

in response to a request for personal information from any of the plurality of Web servers to the at least one user terminal, reading requested user information included in the stored personal information, adding the read personal information to the request, and relaying the personal information with the request to the at least one user terminal.

According to this invention, when relaying personal-information request from the plurality of Web servers to the at least one user terminal via the repeater, the authentication section reads out personal information corresponding to the personal-information request, of the stored user personal information. Subsequently, the authentication section relays set personal information request together with the read personal information affixed to the request, to the user terminal. According to this invention, users need not go through such a troublesome procedure for inputting all of their personal information all the time they make connection to the Internet, etc.

The online shopping method may further comprise:

generating a client identifier for identifying the at least one user terminal at the permitting, and temporarily assigning the at least one user terminal the client identifier which is valid until the at least one user terminal completes connecting to the repeater; and

in a case where target data is relayed together with the client identifier between the at least one user terminal and each of the plurality of Web servers, determining whether a valid client identifier is affixed to the target data to be relayed, and abandoning the target data without relaying the data in a case where it is determined that there is no valid client identifier affixed to the target data.

According to this invention, the client identifier is temporarily assigned to the user terminal at the time of user authentication. The at least one user terminal and the plurality of Web servers affix the assigned client identifier to target data to be sent. The repeater determines whether a valid client identifier is affixed to the target data to be relayed. In a case where it is determined that there is no valid client identifier affixed to the target data, the repeater abandons the target data. Hence, each of the plurality of Web servers can assume that any of those user terminals accessing via the repeater are trusted user terminals, thereby safely realizing the business transactions. Since bills without a valid client identifier are abandoned, unnecessary bills can not be sent from the Web servers.

In order to achieve the above objects, according to the second aspect of the present invention, there is provided an online shopping method for realizing online shopping using: each of a plurality of Web servers for providing online shopping services to at least one user terminal through Internet; a proxy server which is connected to the Internet for relaying data between the at least one user terminal and each of the plurality of Web servers; and a settlement server which acts as a settlement performer for collecting a predetermined amount of money from the at least one user terminal, and the method comprising:

(a) generating a client identifier for identifying the at least one user terminal in response to a request for connecting to the proxy server from the at least one user terminal, temporarily assigning the at least one user terminal the generated client identifier which is valid until the at least one user terminal completes connecting to the proxy server, and permitting the proxy server to connect to the proxy server;

(b) in a case where to relay target data with the client identifier between the at least one user terminal and each of the plurality of Web servers, determining whether a valid client identifier is affixed to the target data in the proxy server, and abandoning the target data in a case where it is determined that there is no valid client identifier affixed to the target data;

(c) cumulatively storing billing data to be sent from each of the plurality of Web servers to the user terminal, of data to be relayed by the proxy server; and

(d) calculating an amount of money to be paid by the user to each of the plurality of Web servers in the settlement server, based on the stored billing data.

In order to achieve the above objects, according to the third aspect of the present invention, there is provided an online shopping system comprising:

a repeater which relays data between at least one user terminal and each of a plurality of Web servers;

an authentication server which stores authentication information for authenticating a user to connect to the repeater, determines whether the user is a proper user based on the stored authentication information, and authorizes the user of the at least one user terminal to access the plurality of Web servers via the repeater,

a memory device which cumulatively stores billing data sent from each of the plurality of Web servers to the at least one user terminal via the repeater, of data to be relayed by the repeater, and

a settlement server which calculates an amount of money to be paid by the user to each of the plurality of Web servers, based on the stored billing data, and acts as a collector for collecting the calculated amount of money from the at least one user terminal.

In order to achieve the above objects, according to the fourth aspect of the present invention, there is provided a computer program product comprising a computer readable recording medium having program codes embodied in the medium, the program codes including:

a first program code for controlling a computer to act as a repeater which relays data between at least one user terminal and a plurality of Web servers;

a second program code for controlling a computer to act as an authentication unit which stores authentication information for authenticating a user to connect to the repeater, determines whether the user is a proper user based on the stored authentication information, and authorizes the user of the at least one user terminal to access the plurality of Web servers via the repeater;

a third program code for controlling a computer to act as a history recorder which cumulatively stores billing data sent from the plurality of Web servers to the at least one user terminal, of data to be relayed via the repeater; and

a fourth program code for controlling a computer to act as a settlement unit which calculates an amount of money to be paid by the user to each of the plurality of Web servers, based on the stored billing data, and as a collector which collects the calculated amount of money from the user.

### BRIEF DESCRIPTION OF THE DRAWINGS

These objects and other objects and advantages of the present invention will become more apparent upon reading of the following detailed description and the accompanying drawings in which:

FIG. 1 is a block diagram showing the schematic structure of preferred embodiments of the present invention;

FIGS. 2A and 2B are diagrams each for explaining roles of a client identifier;

FIG. 3 is a block diagram showing an online shopping system according to the first embodiment of the present invention;

FIG. 4 is a diagram showing the contents of au authentication-information table stored in an authentication server;

FIG. 5 is a diagram showing the contents of a personal-information table stored in a database server;

FIG. 6 is a flowchart for explaining a process for connecting a user terminal to an access server, in the shopping system of FIG. 3;

FIG. 7 is a flowchart for explaining a relaying process realized by a proxy server included in the system of FIG. 3;

FIG. 8 is a flowchart for explaining a process for sending personal information, in the online shopping system of FIG 3;

FIGS. 9A, 9B and 9C arc diagrams respectively showing a personal-information request, a set-personal information request and a personal-information response;

FIG. 10 is a diagram exemplarily showing billing data addressed to a user terminal and created by a Web server;

FIG. 11 is a flowchart for explaining a process for charging a subscriber of an ISP for Internet connection service charges;

FIG. 12 is a flowchart for explaining a settlement process for charging online-shopping charges billed by the Web server;

FIG. 13 is a diagram showing the flow of products and their prices (charges) to be paid, in the online shopping system of FIG. 3;

FIG. 14 is a block diagram showing an online shopping system according to the second embodiment of the present invention;

FIG. 15 is a flowchart for explaining a user authentication process carried out by the online shopping system of FIG. 14; and

FIG. 16 is a block diagram showing a typical example of a conventional online shopping system.

### DETAILED DESCRIPTION OF THE PREFERRED EMBODIMENTS

Preferred embodiments of the present invention will now specifically be described with reference to the accompanying drawings.

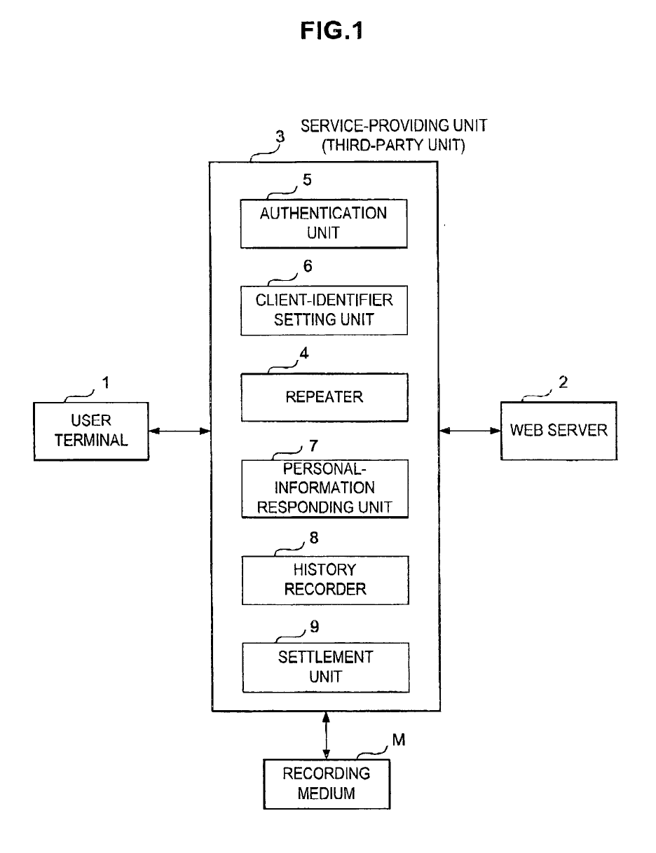

FIG. 1 is a block diagram showing the schematic structure of preferred embodiments of the present invention.

As shown in FIG. 1, the online shopping system comprises a user terminal 1, a Web server 2, and a service-providing unit (third-party unit) 3, which includes repeater 4 and the like.

The user terminal 1 is an information processor, such as a personal computer, etc., and includes a predetermined input/output device, a display device, and the like.

The Web server 2 is an information processor, such as a workstation, etc. for providing online shopping services.

The user terminal 1 and the Web server 2 are connected with each other through the repeater 4, while an online shopping service is being provided.

In fact, a plurality of user terminals 1 and a plurality of Web servers 2 are included in the online shopping system. For the sake of simplicity, however, FIG. 1 shows only one user terminal 1 and one Web server 2 by way of example.

In addition to the above-described repeater 4, the service-providing unit 3 includes an authentication unit 5, a client-identifier setting unit 6, a personal-information responding unit 7, a history recorder 8 and a settlement unit 9.

The authentication unit 5 stores authentication information (e.g. a set of a user name (account name) and a password) of a proper (authorized) user, and performs user authentication for allowing only those proper users to use the repeater 4. The user of the user terminal 1 needs to be authenticated by this authentication unit 5, in the case where the user terminal 1 intends to connect to the repeater 4.

The client-identifier setting unit 6 temporarily assigns the authenticated user terminal 1 a uniquely-set client identifier, and stores the client identifier and the authentication information of the user in association with each other.

In the case where the client identifier needs to be invalid, the client-identifier setting unit 6 invalidates the assigned client identifier. In this case, the client identifier may include, for example, a set of an IP address of the user terminal 1 and time information, representing the time the user is authenticated, in association with each other.

The client identifier is invalidated, when the user terminal 1 completes connecting to the repeater 4. That is, the client identifier is valid during a period of time, since the user terminal 1 is authenticated by the authentication unit 5 until the user terminal 1 completes connecting to the repeater 4. Note that the user terminal 1 has completed connecting to the repeater 4, in the case where the user terminal 1 positively expresses that it intends to complete connecting to the repeater 4, or in the case where no data is transmitted from the user terminal 1 for a predetermined period of time.

When transmitting data to the Web server 2 through the repeater 4, the user terminal 1 affixes the assigned client identifier to the data.

The Web server 2 receives the data to which the client identifier is affixed, from the user terminal 1. In response to this, in the case where the Web server 2 sends predetermined data to the user terminal 1 through the repeater 4, the Web server 2 affixes the same client identifier to the predetermined data to be sent.

The repeater 4 relays between the user terminal 1 and the Web server 2, for transmitting data with a valid client identifier affixed thereto. In the case where the Web server 2 intends to sent a personal-information request, to the user terminal 1, for personal information including a receiver name of a product to be delivered, the addressee for delivery, the phone number of the receiver, etc., the repeater 4 transmits this request to the personal-information responding unit 7. Then, the repeater 4 relays a set-personal information request provided from the personal-information responding unit 7, to the user terminal 1. Further, the repeater 4 sends at least a part of data to be transmitted between the user terminal 1 and the Web server 2, to the history recorder 8

The personal-information responding unit 7 stores personal information (e.g. name, address, phone number of a user) of a proper user. Upon reception of the personal-information inquiry request from the repeater 4, the personal-information responding unit 7 acquires a user ID specified in the client identifier affixed to this request from the client-identifier setting unit 6, and reads personal information of the corresponding user from the stored personal information. The personal-information responding unit 7 sends a set-personal information request, including the inquiry request having the personal information affixed thereto, to the repeater 4.

The history recorder 8 stores at least a part of data to be transmitted between the user terminal 1 and the Web server 2 through the repeater 4, as history data of the user, in association with a user ID affixed thereto. In this case, the history recorder 8 acquires the user ID affixed to the transmission data and specified in the client identifier, from the client-identifier setting unit 6.

The settlement unit 9 sums up the total price of purchased products for each user or each Web server 2, based on the history data stored in the history recorder 8. The settlement unit 9 acts as a collector which collects a predetermined amount of money to be collected and paid from the user terminal 1 to the Web server 2.

In FIG. 1, an alphabetical symbol “M” denotes a machine-readable recording medium, such as a CD-ROM, a semiconductor memory, a magnetic disk unit, etc. The recording medium records a program for controlling the service-providing unit 3. This program is read out by a computer including the third-party unit 3, and controls operations of this computer, so as to realize the repeater 4, the authentication unit 5, the client-identifier setting unit 6, the personal-information responding unit 7, the history recorder 8, and the settlement unit 9.

Operations of the online shopping system having the above-described structure will now be described.

Let it be assumed that the user of the user terminal 1 is represented by “U”, and authentication information of the user is represented by “U1/P1” as a set of the user ID “U1” and a password “P1”. The authentication unit 5 stores “U1/P1”. The personal-information responding unit 7 stores the personal information, such as the name, address, phone number of the user U, in association with the user ID “U1”.

In the case where the user terminal 1 accesses the Web server 2 via the repeater 4 for online shopping, the user terminal 1 inputs the authentication information “U1/P1”. Upon this, the authentication unit 5 determines whether the user is a proper user. In the case where it is determined that the user is a proper user, the client-identifier setting unit 6 assigns the user terminal 1 a client identifier, and stores the assigned client identifier in association with the user ID U1.

The user terminal 1 affixes the assigned client identifier to a request for accessing the Web server 2, and sends this request to the repeater 4. Only in the case where the client identifier assigned to the request is valid, the repeater 4 relays this access request to the Web server 2. The Web server 2 affixes the client identifier to contents of its Web site, and sends the Web site contents to the user terminal 1, which has sent the access request thereto, via the repeater 4. Similarly, the user terminal 1 and the Web server 2 transmits data having the client identifier affixed thereto, via the repeater 4.

The Web server 2 sends, to the repeater 4, the personal-information request, having the client identifier affixed thereto and addressed to the user terminal 1. Upon this, only in the case where the affixed client identifier is valid, the repeater 4 transmits this personal-information request to the personal-information responding unit 7. The personal-information responding unit 7 acquires a user ID “U1” corresponding to the affixed client identifier from the client-identifier setting unit 6, and reads out personal information of the user “U” corresponding to this user ID “U1”. Then, the personal-information responding unit 7 sends a set-personal information request, including the inquiry request having the personal information affixed thereto, to the repeater 4.

Upon reception of the set-personal information request, the repeater 4 relays this request to the user terminal 1.

The user terminal 1 receives the set-personal information request, and displays the received information on a predetermined display device. The user “U” checks the set-personal information request displayed on the display device, and sends the personal information as is if the contents of the set-personal information request is correct.

In the case where the user wants to make a change in the set-personal information request, e.g. in the case where the user wants to change the address for delivery, the user changes only the target part of the personal information, and sends the personal information. Thus checked or changed personal information is sent to the repeater 4 together with the client identifier.

In the case where the affixed client identifier is valid, the repeater 4 sends the personal information to the Web server 2.

The Web server 2 arranges for the delivery of an ordered product, in accordance with the personal information acquired from the user terminal 1. The Web server 2 creates a bill showing information items, including the ordered product, the address for delivery, the amount billed, the slip number of the bill, etc. which are written thereon. The Web server 2 affixes the client identifier to the created bill, and sends the bill to the repeater 4 to which the client identifier is affixed.

In the case where the affixed client identifier is a valid identifier, the repeater 4 relays the bill to the user terminal 1.

In simultaneous with the above-described operations, the repeater 4 transmits at least a part of the data to be sent between the user terminal 1 and the Web server 2, to the history recorder 8.

Upon this, the history recorder 8 acquires a user ID “U1” corresponding to the client identifier affixed to the data, from the client-identifier setting unit 6, stores the data as history data in association with the user ID “U1”. This is because billing data sent from the Web server 2 to the user terminal 1 needs to be retained as history data, so that the settlement can be achieved by the settlement unit 9.

The settlement unit 9 acts as a collector for collecting a predetermined amount of money to be paid by the user terminal 1 to the Web server 2, based on the billing data stored in the history recorder 8. Specifically, the settlement unit 9 searches the history data classified according to user ID and stored in the history recorder 8, for the billing data. After this, the settlement unit 9 calculates the online shopping charge charged to the user having the corresponding user ID, based on the quantity of the ordered products and the unit price thereof which are included in the billing data, and sends the bill to the user.

In the case where the Web server 2 sends a bill for the online shopping to the service-providing unit 3, the settlement unit 9 searches the history data for a bill representing the charge to be paid to this corresponding Web server 2. Then, the settlement unit 9 calculates the online shopping charge to be paid to the Web server 2 and pays the calculated charge, based on the unit price and quantity of the product written in the bill

According to the online shopping systems of the present invention, the service-providing unit 3 acts as the collector for collecting the charge to be paid from the user terminal 1 to the Web server 2. Hence, the user terminal 1 need not inform the Web server 2 about the credit card information.

In the case where the Web server 2 sends a request for personal information, including the addressee for delivery, etc., the personal information which has registered in advance in the service-providing unit 3 is sent to the user terminal in a set format Thus, what the user needs to do is to correct only the necessary part of the personal information.

Further, the client-identifier setting unit 6 temporarily assigns the user terminal 1 a uniquely-set client identifier, at the time of user authentication. When sending data between the user terminal 1 and the Web server 2, the user terminal 1 and the Web server 2 affix the assigned client identifier to the data.

The repeater 4 withdraws an access request having no valid client identifier affixed thereto. Thus, the Web server 2 can assume that any user terminal 1 which access the Web server 2 via the repeater 4 is a trusted user terminal, so that the business can be safely performed between the Web server 2 and the user terminal 1.

The repeater 4 withdraws the billing data having not valid client identifier, and thus obstructing any invalid bills from the Web server 2.

There is proposed another relaying method of relaying only data to/from the user terminal 1 which has been authenticated by the authentication unit 5. According to such a relaying method, a set of the IP address and user ID of the authenticated user terminal 1 is stored. Subsequently, data, which is sent from the user terminal 1 and whose sender IP address does not coincide with the stored IP address, and data, which is sent to the user terminal 1 and whose sender IP address does not coincide with the stored IP address, are invalidated. However, such a method is not adopted in the system of the present invention.

Explanations will now be made to a relaying method of controlling the validity or invalidity of data to be relayed. Note that, in such this relaying method, the client identifier including the IP address and the authentication time information is generated, and the set of the client identifier and user ID is stored.

In the case where the user terminal 1 can not access the Internet only through the ISP, an IP address is automatically assigned to the user terminal 1 when the ISP authenticates the user. The same IP address can not be assigned to different user terminals 1 which are accessing the ISP at the same time. However, in the case where a user terminal 1 has already completed accessing the ISP, the same IP address as that of this user terminal 1 may be assigned to a different user terminal.

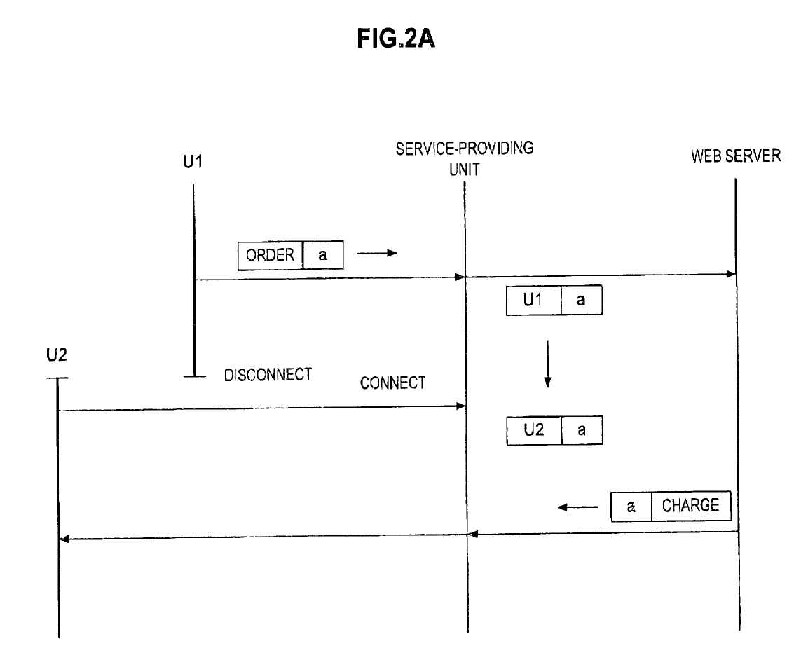

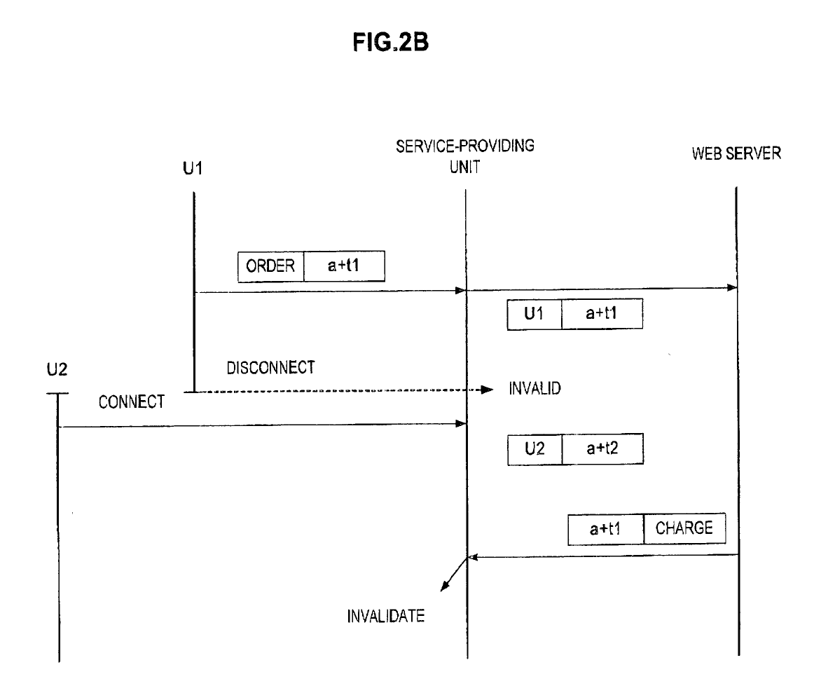

Let it be assumed that an IP address “a” is assigned to the user terminal 1 of a predetermined user “U1”, without any client identifier. As shown in FIG. 2A, in the case where the user “U1” disconnects the line right after he/she has just ordered a product from the Web server 2, the assigned IP address “a” is once invalidated.

After this, the same IP address “a” is assigned to a different user “U2”. At this time, if the Web server 2 sends data regarding the bill of the user “U1”, this data is stored in association with the user “U2”, since the service-providing unit 3 stores the user “U2” as a user corresponding to the IP address “a”. As a result of this, the bill data is relayed to the user “U2”. Hence, in the worst case, the bill may possibly be sent to the user who has not purchased the products claimed in the bill.

Let it be assumed that a client identifier including the IP address “a” and the authentication time “t1” is assigned to the user “U1”. As shown in FIG. 2B, in the case where the user “U1” disconnects the line right after the user “U1” has just ordered a product from the Web server 2, the IP address “a” is once invalidated.

After this, in the case where the same IP address is assigned to the different user “U2”, a client identifier “a+t2” is assigned to the user “U2”. The authentication time of the user “U2” differs from the authentication time “t1” of the user “U1”. Thus, the client identifier “a+t2” differs from a client identifier “a+t1” of the user “U1”.

Further, in the case where the Web server 2 sends data regarding the bill toward the user “U1”, the client identifier affixed to this data is “a+t1” which is not currently valid. Therefore, the data regarding the bill is invalidated. In such circumstances, it is preventable that a bill is sent to the user who has not purchased the products claimed in the bill.

The explanations have been made to the case where the user terminal 1 can access the Internet only through the ISP. The user terminal may be a terminal, which has an IP address for Internet connection so as to directly access the Internet. Even in this case, if a plurality of users having respective user IDs use the same user terminal 1 one after another, a client identifier is necessary for each of the plurality of users.

Specifically, in the case where the IP address “a” is assigned as the user ID without a client identifier, and the user “U1” uses the user terminal 1 having the IP address “a”, for example. In this case, as shown in FIG. 2A, in the case where the user “U1” disconnects the line right after he/she has just ordered a product from the Web server 2, the IP address “a” is invalidated.

After this, the different user “U2” begins to use the same user terminal 1. At this time, if data regarding the bill addressed to the user “U1”, the bill data is stored in association with the user “U2”, because the service-providing unit 3 stores the user “U2” as the user corresponding to the IP address “a”.

Further, this bill data is relayed to the user “U2”. Therefore, in the worst case, the bill may possibly be sent to the user who has not purchased the product claimed in the bill.

A client identifier including, for example, an IP address “a” and the authentication time “t1”, is assigned to the user of the user ID (U1). In this case, as shown in FIG. 2B, if the user “U1” disconnects the line right after the user has just ordered a product from the Web server 2, the IP address “a” is invalidated. After this, even if the different user “U2” uses the same user terminal 1, the client identifier of the user “U2” differs from that of the user “U1”. This is because the client identifier “a+t2” of the user “U2” differs from that of the user “U1”, and the authentication time “t2” of the user “U2” differs from the authentication time “t1” of the user “U1”. Thus, if the Web server 2 sends data regarding the bill for purchased products to the user “U1”, the client identifier “a+t1” is affixed to this data. Because this client identifier “a+t1” is not currently valid, the bill data is invalidated. Therefore, it is preventable that a bill is sent to the user who has not purchased the products claimed in the bill.

According to the present invention, the client identifier is composed of an IP address and the authentication time. However, the client identifier may include only the authentication time. The system of the present invention may include a counter which is incremented every time a client identifier is affixed to data, and a client identifier may be composed of a combination of the counted value and its corresponding IP address or may include the counted value only.

### First Embodiment

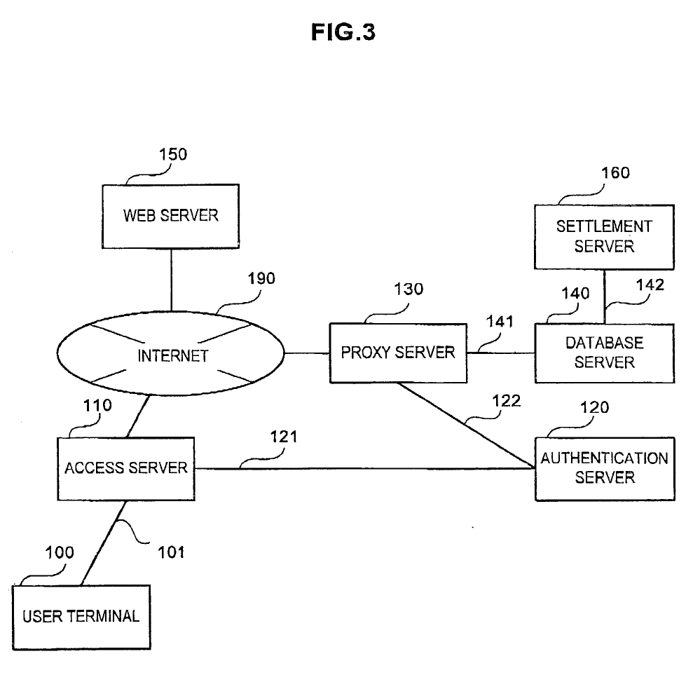

FIG. 3 is a block diagram showing an online shopping system according to the first embodiment of the present invention. In FIG. 3, a user terminal 100 is an information terminal, such as a personal computer, etc. The user terminal 100 includes hardware devices, such as a CPU, a memory, a keyboard, a CRT, a modern and the like, and has necessary software including the browser, etc. installed therein. A Web server 150 is an information processor, such as a workstation, etc. for providing online shopping services. The Web server 150 has hardware devices, such as a CPU, a memory, a modem, etc. and necessary software, for acting as a server, installed therein. Note that there exist a plurality of user terminals and a plurality of Web servers, however, only one user terminal and only one Web server are illustrated in FIG. 3, by way of example.

In FIG. 3, the service-providing unit 3 of FIG. 1 comprises an access server 110, an authentication server 120, a proxy server 130, a database server 140 and a settlement server 160. This service-providing unit 3 is managed by an ISP that the user of a user terminal 100 has subscribed to. In this embodiment, the ISP acts as the service-providing unit 3. The access server 110 and the proxy server 130 are connected to Internet 190. The authentication server 120 is connected to the access server 110 and the proxy server 130 respectively through communications lines 121 and 122. The database server 140 is connected to the proxy server 130 and the settlement server 160 respectively through communications lines 141 and 142.

The user terminal 100 is connected to the access server 110 of an ISP through a subscribers' line 101. The user of the user terminal 100 is connected to the access server 110 through dial-up connection, when accessing the Web server 150 through the Internet 190. The user of the user terminal 100 gets an IP address and a client identifier assigned thereto, and uses the Internet connection service. In the case where the user terminal 100 sends data, it sets the assigned IP address as a sender address. When accessing the Web server 150 through the proxy server 130, the user terminal 100 affixes the assigned client identifier to request data for accessing the Web server 150.

The access server 110 assigns an IP address to the user terminal 100 which has connected thereto. For user authentication, the access server 110 sends this IP address and user-input authentication information to the authentication server 120 through the communications line 121. Only in the case where the user is successfully authenticated, the access server 110 sends the IP address and a client identifier sent from the authentication server 120, to the user terminal 100, and provides the user terminal 100 with an Internet connection service.

In the case where the access server 110 is disconnected from the user terminal 100, or in the case where the user terminal 100 has sent no data to the access server 110 for a predetermined period of time, the access server 110 informs the proxy server 130 about the user ID of the user terminal 100 via the Internet 190. This client identifier corresponding to the user ID is invalidated by the proxy server 130.

The authentication server 120 stores authentication information (e.g. a combination of a user name (account name) and its corresponding password) of each subscriber of the ISP, in advance. The authentication server 120 has a function for generating client identifiers.

Upon reception of an IP address and authentication information from the access server 110, the authentication server 120 determines whether the received authentication information coincides with the user-authentication information stored in advance in the authentication server 120.

In the case where it is determined that the received authentication information coincides with the stored information, the authentication server 120 affixes present-time information affixed to the IP address, sent from the access server 110 together with the user authentication information, so as to generate a client identifier. The authentication server 120 sends the generated client identifier together with the determination result to the access server 110 through the communications line 121. Further, the authentication server 120 sends this client identifier together with the user ID included in the user authentication information, to the proxy server 130 via the communications line 122.

In the case where it is determined the received authentication information does not coincide with the stored information, the authentication server 120 sends the determination result to the access server 110, and the access server 110 sends this determination result to the user terminal 100, thereby refusing the connection to the Internet 190.

The proxy server 130 relays between the user terminal 100 and the Web server 150. The proxy server 130 stores, in an internal memory, a set of a user ID and client identifier sent from the authentication server 120.

Upon reception of a user ID corresponding to a client identifier to be invalidated from the access server 110, the proxy server 130 erases a corresponding set of a user ID and a client identifier from the internal memory.

Of data sent from the user terminal 100 to the Web server 150 and data sent from the Web server 150 to the user terminal 100, the proxy server 130 relays only data, to which the same client identifier as the internally-stored client identifier is affixed. Further, the proxy server 130 detects a personal-information request which is sent from the Web server 150 to the user terminal 100, and acquires corresponding user personal information from the database server 140.

After this, the proxy server 130 affixes the detected request to the acquired personal information so as to generate a set-personal information request, and relays the generated set-personal information request to the user terminal 100. The proxy server 130 transmits billing data to the database server 140, so as to record the transmission history of the billing data sent from the Web server 150 to the user terminal 100.

The database server 140 stores personal information (including a name, address, phone number, etc.) of each subscriber of the ISP, in association with user ID. The database server 140 stores the billing data transmitted from the proxy server 130 in association with user ID, and sends the billing data in response to a request from the settlement server 160.

The settlement server 160 charges each subscriber of the ISP for the Internet connection service provided thereto. The settlement server 160 specifies a predetermined user ID, and acquires billing data corresponding to the specified user ID from the database server 140. The settlement server 160 acts as a charge collector for collecting the service charge to be paid by the user terminal 100 to the Web server 150.

Several operations (1) to (6) of the online shopping system according to this embodiment will now be described.

(1) Preparation Stage

In the preparation stage, the user of the user terminal 100 registers user-authentication information necessary for dial-up connection to the ISP, into the authentication server 120. The user registers his/her personal information into the database server 140.

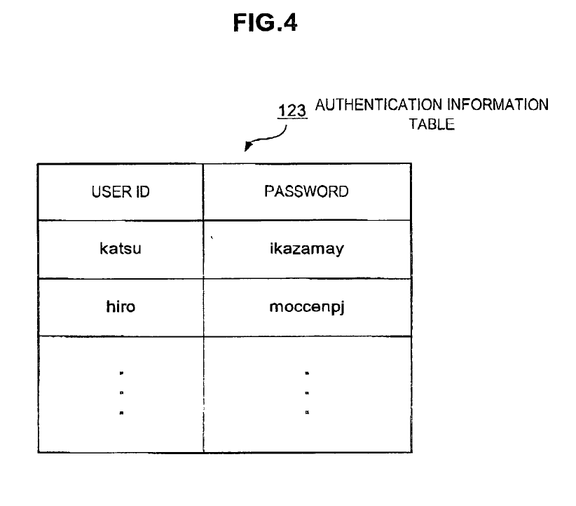

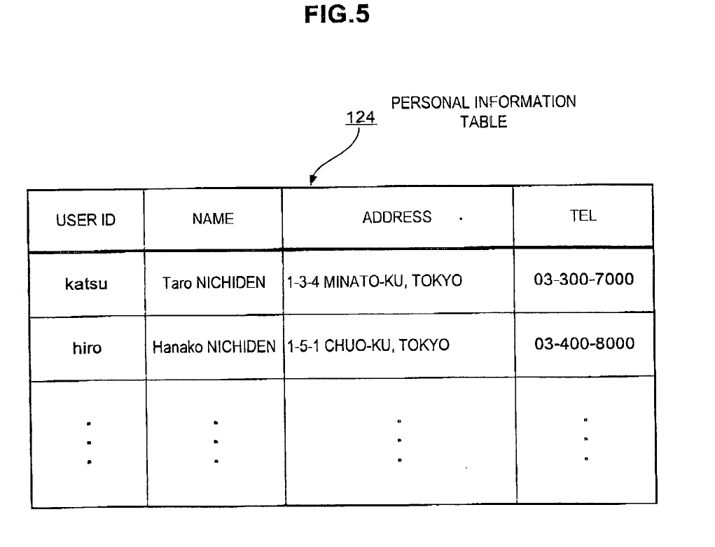

FIG. 4 shows an example of an authentication-information table 123 that the authentication server 120 has. FIG. 5 shows an example of a personal-information table 124 that the database server 140 has. Note that the user-authentication information is composed of a set of a user ID and its corresponding password, and that the personal information is composed of a name, address and phone number of each user, in association with each user ID.

(2) Stage for Connecting User Terminal to Access Server

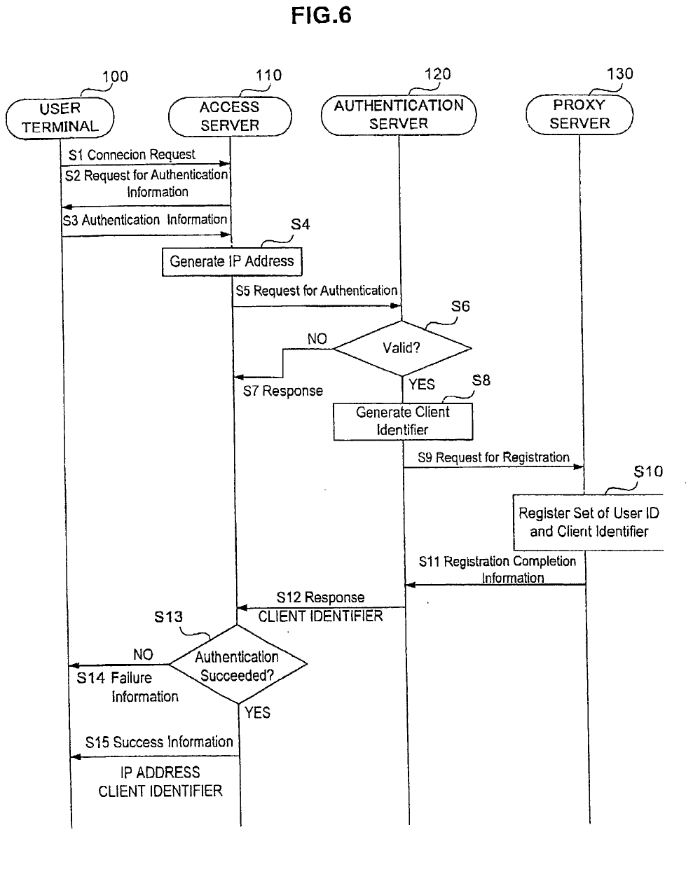

FIG. 6 shows a flowchart for explaining the process in a stage for connecting the user terminal 100 to the access server 110.

The user terminal 100 sends, to the access server 110, a connection request through dial-up connection to the access server 110 via the subscribers' line 101 using a modem installed in the user terminal 100 (Step S1).

Upon reception of this connection request from the user terminal 100, the access server 110 requests the user terminal 100 to input authentication information (Step S2). In response to the request, the user sends the authentication information from the user terminal 100 to the access server 110 (Step S3).

The access server 110 receives this authentication information from the user terminal 100, and assigns the user terminal 100 an IP address (Step S4). The access server 110 sends the assigned IP address and the input authentication information input by the user terminal 100 to the authentication server 120, via the communications line 121, and requests the authentication server 120 for user authentication (Step S5).

The authentication server 120 collates the received authentication information with authentication information registered in advance in the authentication-information table 123, thereby determining whether the received authentication information is valid (Step S6).

In the case where the received authentication information does not coincide with any authentication information in the authentication-information table 123, the authentication server 120 determines that the user-input authentication information is not valid, and sends failure-information representing that the user is not successfully authenticated to the access server 110 via the communications line 121 (Step S7).

On the contrary, in the case where the received authentication information coincides with the information in the authentication-information table 123, the authentication server 120 determines that the user-input information is valid, and generates a client identifier, which includes the sent IP address and the present-time information (Step S8). The authentication server 120 sends the generated client identifier and the user ID included in the authentication information to the proxy server 130 via the communications line 122, and requests the proxy server 130 to register them (Step S9).

The proxy server 130 stores the sent client identifier and user ID in its internal memory (Step S10). The proxy server 130 sends information representing that the client identifier and the user ID have been completely registered.

Upon reception of this information representing the completion of the registration (Step S11), the authentication server 120 sends success information representing that the user has successfully been authenticated, together with the client identifier affixed to the success information, to the access server 110 via the communications line 121 (Step S12).

The access server 110 determines whether information sent from the authentication server 120 is the success information or failure information (Step S13).

In the case of the failure information, the access server 110 does not authorize the user terminal 100 to connect to the Web server 150 (Step S14). In this case, the IP address generated in the step S4 is invalidated.

On the contrary, in the case of the success information, the access server 110 sends connection-authorization information to the user terminal 100, together with the IP address generated in the step S4 and the client identifier generated by the authentication server 120 (Step S15).

(3) Relaying by Proxy Server

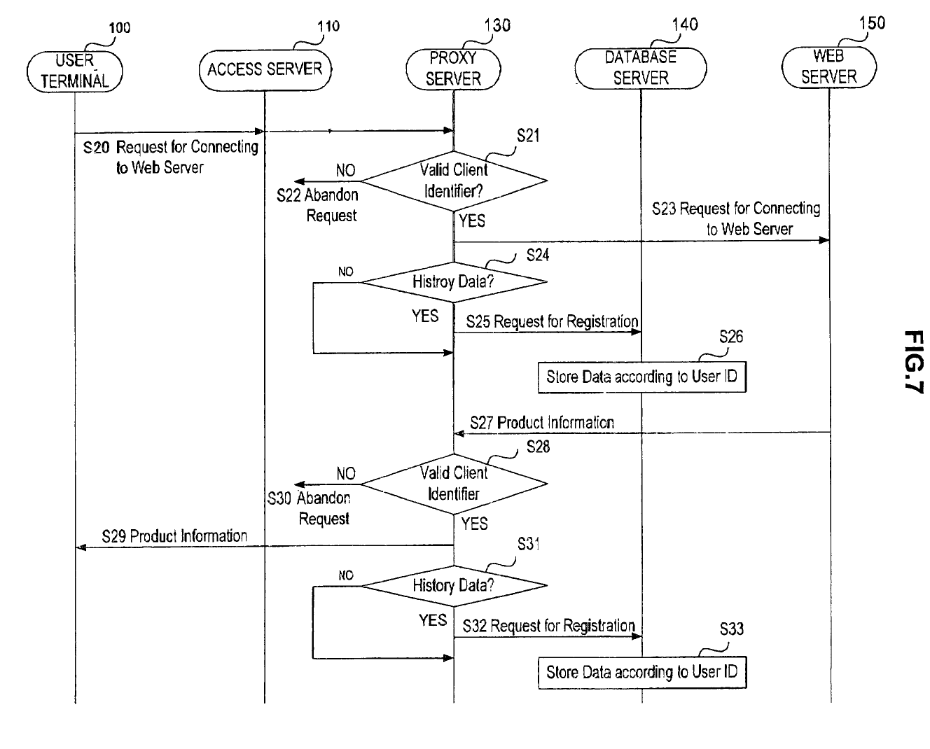

FIG. 7 shows a flowchart for explaining this stage for executing a process for relaying data.

In the case where the user of the user terminal 100, having been authorized to connect to the Web server 150, accesses the Web server 150, the user terminal 100 sends a connection request for connecting to the Web server 150 thereto, via the proxy server 130, together with the assigned client identifier (Step S20).

The proxy server 130 determines whether there is a client identifier affixed to the data received from the user terminal 100. In the case where it is determined that a client identifier is affixed to the received data, the proxy server 130 determines whether this client identifier coincides with any of client identifiers registered in its internal memory, so as to determine the validity of the client identifier (Step S21).

In the case where it is determined that there is no client identifier affixed to the received data or that the affixed client identifier is not valid, the proxy server 130 does not relay between the user terminal 100 and the Web server 150, and abandons the request to the Web server 150 (Step S22).

In the case where a valid client identifier is affixed to the received data, the proxy server 130 relays the connection request to the Web server 150 (Step S23). The proxy server 130 determines whether this relayed data should be stored as history data (Step S24).

Only in the case where the data should be stored, the proxy server 130 acquires a user ID corresponding to the client identifier of the data, from the internal memory. Then, the proxy server 130 sends the data to the database server 140 via the communications line 141, together with the user ID, and requests the database server 140 to register the sent data (Step S25). Note that specific explanations will later be made to a method of determining what data should be stored as history data. The database server 140 stores those data that the proxy server 130 has requested to register, according to user ID (Step S26).

Upon successful reception of the connection request from the user terminal 100, the Web server 150 sends a Web page including information regarding various products to be provided, to the user terminal 100 via the proxy server 130 (Step S27). In this case, the Web server 150 sends the Web page to the user terminal 100, together with the client identifier affixed to the connection request.

The proxy server 130 checks the validity of the client identifier likewise the case of the step S21 (Step S28). In the case where a valid client identifier is affixed to the connection request, the proxy server 130 relays the Web page to the user terminal 100 (Step S29).

On the contrary, in the case where a valid client identifier is not affixed to the connection request, the proxy server 130 abandons this request without relaying it to the Web server 150 (Step S30).

Likewise in the step S24, the proxy server 130 determines whether the Web page is history data to be recorded (Step S31). In the case where it is determined that the data to be relayed is the history data, the proxy server 130 acquires a user ID corresponding to a client identifier affixed to the data from the internal memory. The proxy server 130 sends this data to be relayed to the database server 140 via the communications line 141, together with the acquired user ID, and requests the database server 140 to register the sent data (Step S32).

Upon reception of the data and the user ID from the proxy server 130, the database server 140 stores the data that the proxy server 130 has requested to register, in association with their user IDs (Step S33).

After this, in the case where data transmission is performed between the user terminal 100 and the Web server 150, the same operations as those described above are performed by the proxy server 130. Explanations will now be made to a predetermined process which is carried out by the proxy server 130 in the case where the Web server 150 sends a personal-information request to the user terminal 100.

(4) Stage for Sending Personal Information Response

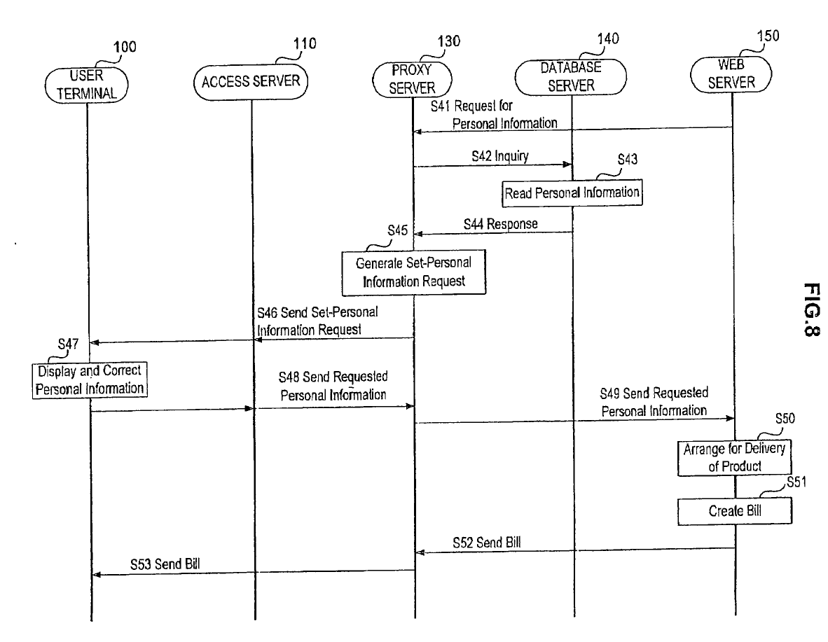

FIG. 8 is a flowchart for explaining a process for sending personal information. Likewise the above, in this stage (4), the proxy server 130 determines whether the affixed client identifier is valid and whether the data to be relayed is the history data. However, such determinations will not be shown again in FIG. 8. Let it be assumed that the user of the user terminal 100 has selected a predetermined product item to be purchased on a Web page provided by the Web server 150, in this stage (4).

The Web server 150 sends a request for user personal information to the user terminal 100 via the proxy server 130, when delivering the product item ordered by the user of the user terminal 100 (Step S41).

Upon reception of the request for user personal information from the Web server 150, the proxy server 130 reads out a user ID corresponding to a valid client identifier affixed to the received request from its internal memory, and requests the database server 140 for the personal information while specifying the read user ID (Step S42). The database server 140 searches the personal-information table 124 for corresponding personal information, with reference to the user ID (Step S43). The database server 140 sends the searched personal information to the proxy server 130 via the communications line 141 (Step S44).

Upon reception of the personal information from the database server 140, the proxy server 130 adds the personal information to the personal-information request sent from the Web server 150 in the step S41, so as to generate a set-personal information request (Step S45). After this, the proxy server 130 sends the generated set-personal information request to the user terminal 100 (Step S46).

The user terminal 100 displays the received set-personal information request, so that the user can check or correct the displayed personal information thereon (Step S47). The user checks the contents of the set-personal information request, and sends the personal information as is if the contents of the set-personal information request is correct. In the case where the user wants to change a part of the personal information, the user corrects the personal information, executes an operation for sending the corrected personal information, and sends the requested personal information to the Web server 150 via the proxy server 130 (Step S48).

Upon reception of the personal information from the user terminal 100, the proxy server 130 relays the personal information to the Web server 150, only in the case where a valid client identifier is affixed to the information (Step S49).

The Web server 150 arranges for delivery of the product ordered, based on the personal information shown in the received personal information (Step S50). The Web server 150 creates a bill addressed to the user terminal 100 for the product ordered (Step S51), and sends the created bill to the proxy server 130 (Step S52).

Upon reception of the bill from the Web server 150, the proxy server 130 relays the received bill to the user terminal 100, only in the case where a valid client identifier is affixed thereto (Step S53).

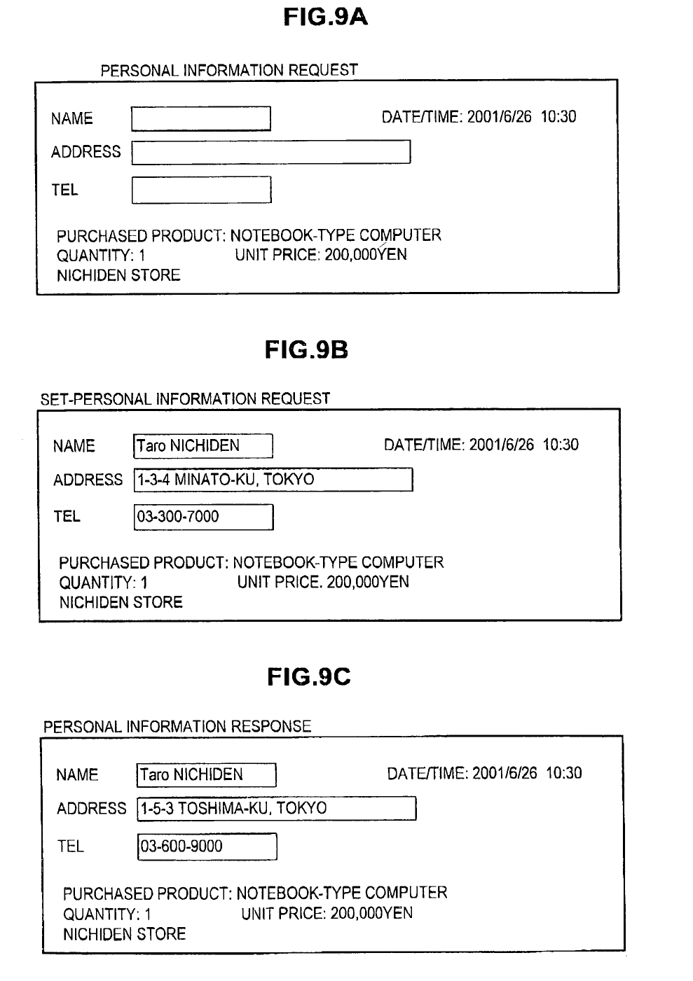

FIG. 9A exemplarily shows the personal-information request sent by the Web server 150. As shown in FIG. 9A, in addition to display sections for displaying those information items including: a user-selected product item to be purchased; the quantity of the product items; the unit price; a Web shop name; the present date/time, there are input sections for inputting the name, address and phone number of a corresponding user. All of the input sections are blank in the personal-information request.

FIG. 9B exemplarily shows a set-personal information request generated by the proxy server 130.

As shown in FIG. 9B, the user name, the user address and the phone number which are shown in the personal information are set in the respective input sections.

The set personal information request is sent to the user terminal 100. In the case where the user is satisfied with the set-personal information request, the user need not input his/her personal information at all.

In the case where the user wants to change the addressee for delivery, the user simply corrects the address shown in the set-personal information request, and sends the corrected information to the Web server 150.

FIG. 9C exemplarily shows a personal-information response which has been corrected by the user and sent therefrom.

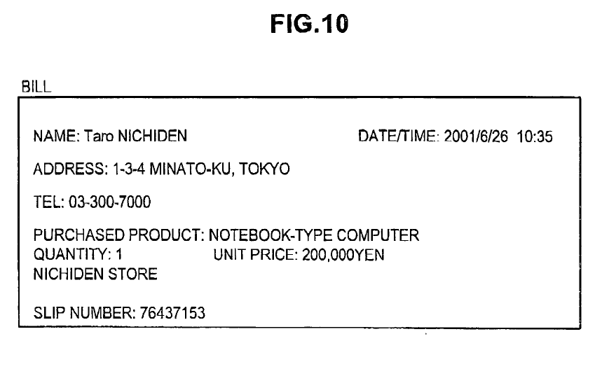

FIG. 10 shows an example a bill, which is created by the Web server 150 and addressed to the user terminal 100. This bill shows: the product name ordered by the user; the quantity of the product; the unit price of the product; a corresponding Web shop name; a slip number of the bill; the present date/time; and the user name and address and phone number which are specified in the set-personal information request.

(5) Method of Detecting History Data to Be Recorded

According to one method of detecting history data, a model of data to be recorded as history data is registered in advance, and data which coincides with the registered model is set as target history data to be recorded.

For example, with reference to the billing data shown in FIG. 10, such history data to be recorded is described in the form of HTML text or XML text, and the format of the description is determined in accordance with each Web server 150. Thus, formats of the billing data are registered in advance in the proxy server 130, and it is determined whether the format of data to be relayed coincides with any of the registered formats. By so doing, it can be detected whether the data to be relayed is the history data to be recorded.

According to a similar method, the personal-information request shown in FIG. 9A and the personal-information response shown in FIG. 9C can be set as history data to be recorded. This method can be used for detecting the personal-information request, in the proxy server 130.

According to another method, a predetermined symbol representing whether to store as history data is affixed to target data to be sent, and the target data with the symbol affixed thereto is sent from the Web server 150 or the user terminal 100 to the proxy server 130. Upon reception of the target data, the proxy server 130 determines whether the target data is history data to be recorded, based on the predetermined symbol affixed to the target data. This method can be used for detecting the personal information request in the proxy server 130. Note that the predetermined symbol may be formed in any predetermined bit string. In addition, the predetermined symbol may be affixed to the data in accordance with the same manner as that of the client identifier, or may be affixed to the header or body section of HTML text or XML text. The kind (the billing data, the personal-information request, etc.) of the target data may be identifier based on the predetermined symbol. Further, in the case where the target data to be sent is the personal information request, if the context (address, phone number, etc.) of requested personal information is specified in the header section in association with the predetermined symbol, it is not necessary to analyze the body section of the text. This results in the improvement of the process efficiency.

(6) Stage for Making/Paying Bill for Product/Service

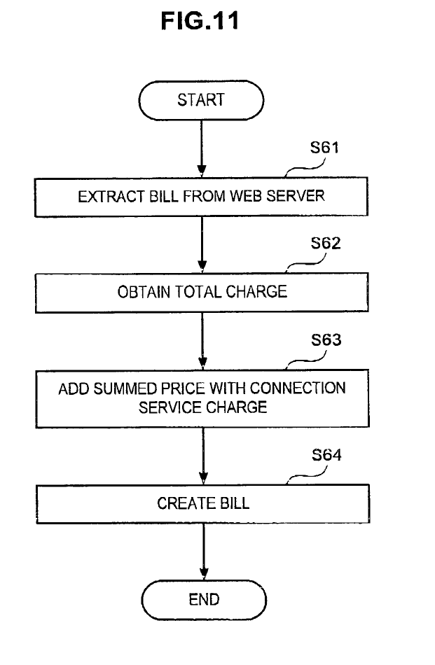

When making a bill for an Internet-connection service to each subscriber of an ISP, the settlement server 160 sends a bill(s) for online-shopping to the subscriber. FIG. 11 shows a flowchart for explaining a process for making bill for each subscriber.

From the history data stored in the database server 140 according to user ID, the settlement server 160 extracts all non-transmitted billing data shown in FIG. 10, which has not yet been sent to the user, in association with the user ID of the subscriber (Step S61). Next, the settlement server 160 multiplies the quantity of products written in the bill by the unit charge, so as to obtain the amount billed per transaction, and obtains the total charge for the entire bills to be sent to the subscriber (Step S62). The settlement server 160 adds the summed total charge with the Internet-connection service charge addressed to the subscriber (Step S63), so as to make a bill addressed to the user (Step S64). At the time of making this bill, the settlement server 160 affixes a predetermined mark representing that the bill is issued, to the processed billing data, and stores the billing data with the predetermined mark affixed thereto, in the database server 140. The bill addressed to the user includes not only the calculated total charge, but also the detail statement of online shopping charges. This detail statement is formed based on the billing data sent from the Web server 150. Thus created bill addressed to the user is sent to the subscriber by post, and the amount billed is collected in accordance with a predetermined method (e.g. directly paying from the user's bank account, etc.).

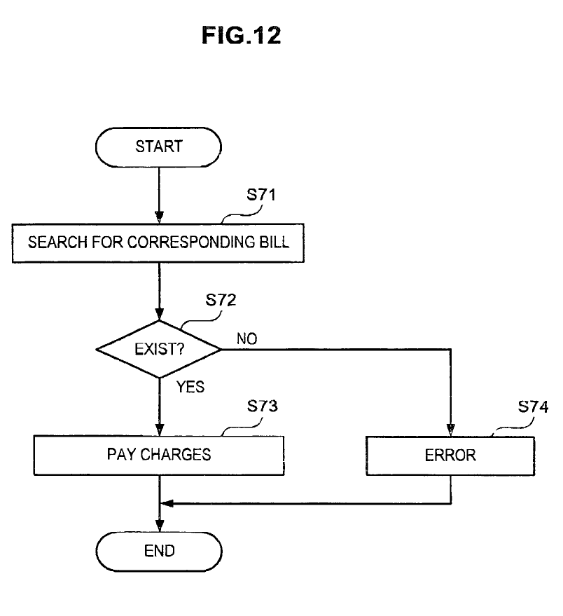

When the Web server 150 requests payment for online shopping charges, the settlement server 160 calculates the online shopping charges to be paid to the Web server 150, based on the billing data stored in the database server 140. After this, the settlement server 160 pays the calculated charges to the Web server 150, in accordance with a predetermined payment method, for example, a payment method directly to the specified bank account by the Web server 150. FIG. 12 shows a settlement process for paying the charges for each transaction.

Upon reception of a bill indicating a predetermined slip number of a bill from the Web server 150, the settlement server 160 searches the database server 140 for the billing data in association with the indicated bill number (Step S71). If there are different non-transmitted billing data having the same bill number (Step S72; YES), the settlement server 160 multiplies the quantity of the products written in the bill by the unit charge of the products, so as to obtain the amount billed per transaction, and pays the obtained amount of money to the Web server 150 (Step S73). In this case, the Web server 150 may add a predetermined service charge into the bill. In the case where the payment is successfully performed, the settlement server 160 affixes the predetermined symbol representing that the payment has been accomplished to the processed billing data, and stores the billing data with the symbol in the database server 140.

In the case where there is no corresponding billing data (Step S72: NO), the settlement server 160 executes an error process (Step S74).

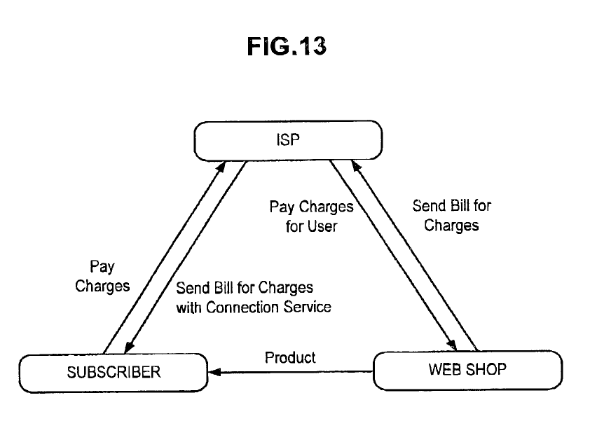

FIG. 13 shows the flow of products and their prices (charges) to be paid, in the online shopping system according to this embodiment.

A Web shop delivers a product ordered by the user (the subscriber) to the address for delivery, in accordance with an order sent from the user terminal 100 to the Web server 150, and sends a bill for the product to the ISP.

If the ISP receives a bill addressed to the user from the Web shop, the ISP pays the amount billed in the received bill for the user, and charges the user for the paid amount of money. In this case, the ISP collects the online shopping charges at the same time it collects the Internet service charge, from the user. The user receives the product from the Web shop, and paid the charge to the ISP.

### Second Embodiment

According to the second embodiment of the present invention, the user terminal has an IP address only for the Internet, and the user terminal can connect directly to the Internet.

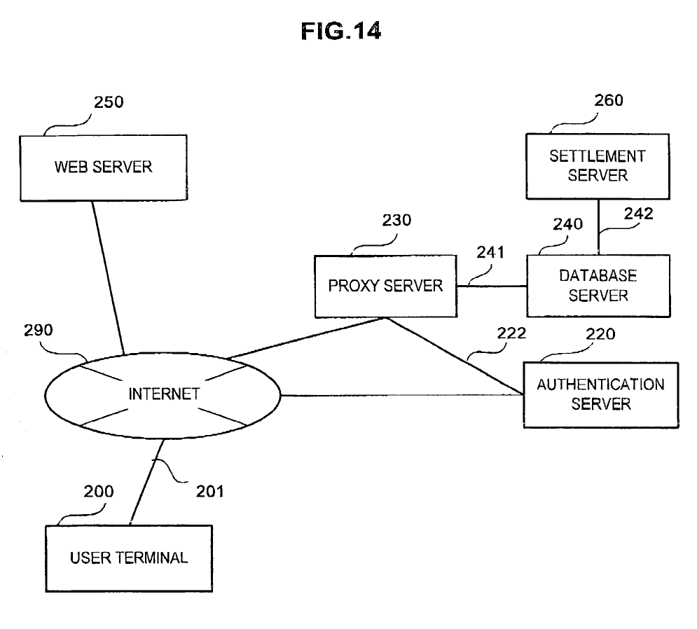

FIG. 14 is a block diagram showing an online shopping system according to the second embodiment of the present invention.

In FIG. 14, a user terminal 200 is an information processor, such as a personal computer, etc. The user terminal 200 includes hardware devices, such as a CPU, a memory, a keyboard, a CRT, a modem and the like, and has necessary software including the browser, etc. installed therein. Unlike the user terminal 100 included in the system or the first embodiment, the user terminal 200 includes a communications interface for directly connecting to Internet 290. Thus, the user terminal 200 is connected directly to the Internet 290 through a communications line 201.

A Web server 250 is an information processor, such as a workstation, etc. for providing online shopping services, includes hardware devices, such as a CPU, a memory, a keyboard, a CRT, a modem, and the like, and has necessary software including the browser, etc. installed therein.

FIG. 14 shows only one user terminal and one Web server by way of example. However, in fact, there are a plurality of user terminals and Web servers over the Internet.

The service-providing unit 3 comprises an authentication server 220, a proxy server 230, a database server 240 and a settlement server 260, and is managed by the same business organization as that of the first embodiment. The authentication server 220 and the proxy server 230 are connected to the Internet 290 and with each other through a communications line 222. The database server 240 is connected to the proxy server 230 and a settlement server 260 respectively through communications lines 241 and 242.

The user terminal 200 accesses a Web server 250 through the proxy server 230. The user terminal 200 is authenticated by the authentication server 220 to use the proxy server 230, and the proxy server 230 assigns the user terminal 200 a client identifier. The user terminal 200 affixes the assigned client identifier to an access request for accessing the Web server 250 through the proxy server 230. When the user terminal 200 completes using the proxy server 230, it sends information representing the completion of using the Web server 250 to the authentication server 220, together with the user ID.

The authentication server 220 stores authentication information (e.g. a set of a user name (account name) and a passsword) of each member using the proxy server 230. The authentication server 220 has a function for generating client identifiers. Upon reception of authentication information from the user terminal 200, the authentication server 220 determines whether the received authentication information coincides with valid authentication information registered in advance therein. In the case where it is determined that the transmitted authentication information coincides with the registered information, the authentication server 220 sets a set of an IP address of the user terminal 200 and the authentication time, as a client identifier. The authentication server 220 sends the set client identifier with the user ID included in the authenticaton information, to the proxy server 230 through the communications line 222.

When the authentication server 220 receives the information representing the completion of using the Web server 250, from the user terminal 200 together with the user ID, the authentication server 220 instructs the proxy server 230 to invalidate the client identifier corresponding to the user ID of the user terminal 200.

The proxy server 230 has a function for relaying data between the user terminal 200 and the Web server 250. The proxy server 230 stores the set of the user ID and the client identifier which are sent from the authentication server 220, in its internal memory. Upon reception of the instruction for invalidating the client identifier from the authentication server 220, the proxy server 230 invalidates the set of the user ID and the client identifier specified in the invalidation instruction. In addition, in the case where there is no data transmission from the user terminal 200 for a predetermined period of time, the proxy server 230 invalidates the stored set of the user ID and the client identifier. Other than the above, the proxy server 230 has the same function as that of the proxy server 130 included in the online shopping system of the first embodiment.

The database server 240 and the settlement server 260 have the same function as those of the database server 140 and the settlement server 160 described in the first embodiment.

Operations of the online shopping system according to the second embodiment of the present invention will now be described, mainly focusing on the difference(s) with respect to the first embodiment.

For preparation, the authentication information of the user terminal 200 is registered in the authentication server 220, likewise the case of FIG. 4, and personal information of the user of the user terminal 200 is registered in the database 240, likewise the case of FIG. 5.

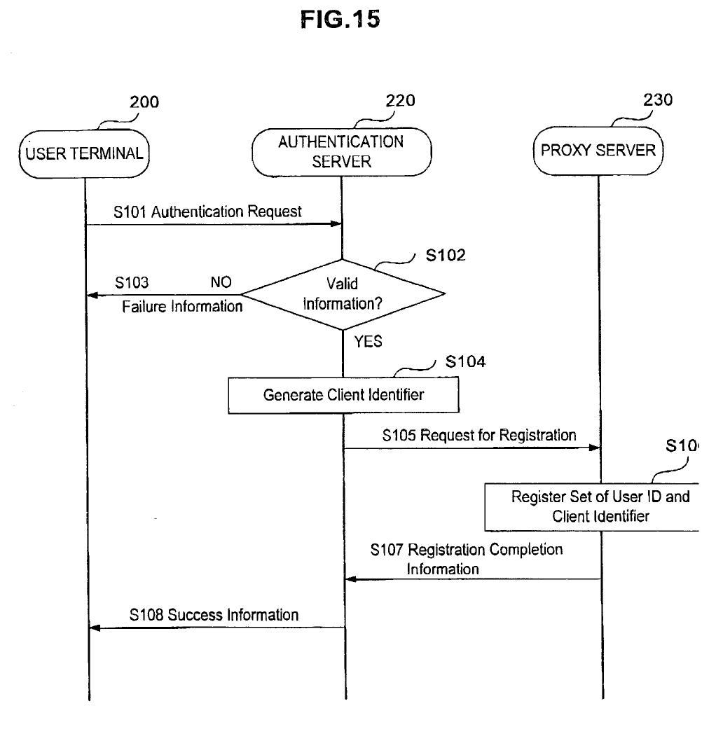

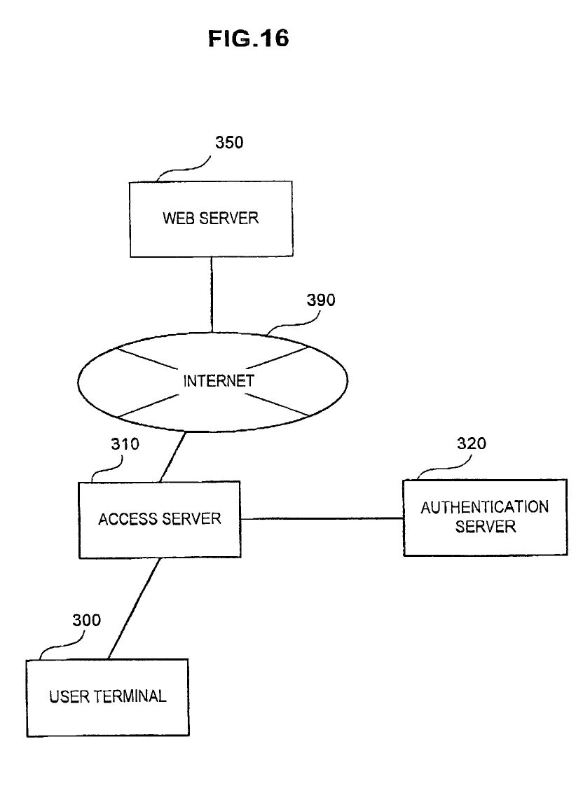

FIG. 15 shows a flowchart for explaining a process for authenticating the user terminal 200.

The user of the user terminal 200 sends an authentication request for connecting to the proxy server 230 to the authentication server 220 through the Internet, together with the authentication information (Step S101).

The authentication server 220 collates the received authentication information with the authentication information registered in the authentication-information table 123 shown in FIG. 4, thereby determining whether the received authentication information is valid (Step S102).

In the case where it is determined that the received authentication information does not coincide with any authentication information registered in the table, the authentication server 220 determines that the user-input authentication information is not valid. After this, the authentication server 220 sends a denial response representing that the requested connection can not be made, to the user terminal 200 through the Internet 290 (Step S103).

On the contrary, in the case where it is determined that the received authentication information coincides with that registered in the table 123, the authentication server 220 determines that the user-input information is valid, and generates a client identifier using the IP address of the user terminal 200 and the present time (Step S104). The authentication server 220 sends a set of the generated client identifier and the user ID specified in the authentication information to the proxy server 230 through the communications line 222, so as to request the proxy server 230 to register the set of the client identifier and user ID (Step S105). The proxy server 230 stores the received set of the client identifier and the user ID in its internal memory (Step S106).

Upon reception of a response representing that the set of the client identifier and the user ID has completely been registered (Step S107), the authentication server 220 sends success information representing that the user terminal 200 can connect to the Web server 250, to the user terminal 200, together with the client identifier (Step S108)

In the case where to access the Web server 250, the user of the user terminal 200 which is allowed to connect to the Web server 250 in the step S108 sends a connection request to the Web server 250 through the proxy server 230, together with the assigned client identifier. Subsequent operations are the same as those described in the first embodiment. Note that there is no access server between the user terminal 200 and the proxy server 230 in the online shopping system of this embodiment, unlike the structure of the first embodiment.

As explained above, according to the present invention, the user can utilize the online shopping services, without the risk of transmitting credit-card information over public networks. This is because the third-party unit acts as a collector which collects the service charges for the online shopping, that should be paid from the user terminal to the Web server. Thus, those users who do not possess any credit card can use the online shopping services.

The user can simply access the Web server via the repeater 4 through easy processes, so that the online shopping services can also easily realized.

The Web server can assume that a user terminal which accesses through the repeater is a trusted user terminal, thereby safely realizing the business between the two. This is because only the user which has been authenticated by the third-party unit can access the Web server.

A bill without a valid client identifier assigned to the user terminal is invalidated, thereby preventing any invalid bills from being sent to the user.

The third-party unit can acquire information representing any products purchased by the user at the Web shop, thereby also acquiring information representing user preferences in a certain field. For example, those Web pages that the user has browsed may be stored as history data, other than the billing data, the online shopping system of the present invention can acquire the user preferences more specifically.

The system of the present invention can be realized by a general computer, without the need for a dedicated system. A program and data for controlling a computer to execute the above-described processes may be recorded on a medium (a floppy disk, CD-ROM, DVD or the like) and distributed, and the program may be installed into the computer and run on an OS (Operating System) to execute the above-described processes, thereby achieving the system of the present invention. The above program and data may be stored in a disk device or the like in the server device on the Internet, and embedded in a carrier wave. The program and data embedded in the carrier wave may be downloaded into the computer so as to realize the system of the present invention.

Various embodiments and changes may be made thereonto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2001-196326 filed on Jun. 28, 2001, and including specification, claims, drawings and summary. The disclosure of the above Japanese Patent Application is incorporated herein by reference in its entirety.

What is claimed is:

1. An online shopping method comprising:
storing user-authentication information necessary for an authentication section to perform user authentication, said authentication section having a repeater for relaying data between at least one user terminal and a plurality of Web servers;
determining whether a user of said at least one user terminal is a proper user in a case where said at least one user terminal intends to access said authentication unit, and permitting said at least one user terminal to access said plurality of Web servers through said repeater in a case where it is determined that said user of said at least one user terminal is a proper user;
recording billing data, sent from each of said plurality of Web servers in response to an order for a product item from said at least one user terminal, of data to be relayed by said repeater between each of said plurality of Web servers and said at least one user terminal; and
in said authentication section, calculating an amount of money to be paid by said user to each of said plurality of Web servers based on the recorded billing data, and acting as a collector for collecting the calculated amount of money to be paid by said user to each of said plurality of Web servers.

2. The online shopping method according to claim 1, wherein
said authentication section executes said acting as a collector for collecting the calculated amount of money, using an account of said user which is prepared for paying for charges for connecting to said repeater and a specified account of each of said plurality of Web servers.

3. The online shopping method according to claim 2, wherein
said authentication section is an ISP (Internet Service Provider).

4. The online shopping method according to claim 1, further comprising, in said authentication section:
storing personal information specifying the user; and
in response to a request for personal information from any of said plurality of Web servers to said at least one user terminal, reading requested user information included in the stored personal information, adding the read personal information to the request, and relaying the personal information together with the request to said at least one user terminal.

5. The online shopping method according to claim 1, further comprising:
generating a client identifier for identifying said at least one user terminal at said permitting, and temporarily assigning said at least one user terminal said client identifier which is valid until said at least one user terminal completes connecting to said repeater; and
in a case where target data is relayed together with said client identifier between said at least one user terminal and each of said plurality of Web servers, determining whether a valid client identifier is affixed to the target data to be relayed, and abandoning the target data without relaying the data in a case where it is determined that there is no valid client identifier affixed to the target data.

6. The online shopping method according to claim 3, wherein the client identifier includes an IP address of said at least one user terminal and time information representing time user authentication of the user is performed.

7. An online shopping method for realizing online shopping using: each of a plurality of Web servers for providing online shopping services to at least one user terminal through Internet; a proxy server which is connected to said Internet for relaying data between said at least one user terminal and each of said plurality of Web servers; and a settlement server which acts as a settlement performer for collecting a predetermined amount of money from said at least one user terminal, and said method comprising:
(a) generating a client identifier for identifying said at least one user terminal in response to a request for connecting to said proxy server from said at least one user terminal, temporarily assigning said at least one user terminal said generated client identifier which is valid until said at least one user terminal completes connecting to said proxy server, and permitting said proxy server to connect to said proxy server;
(b) in a case where to relay target data with said client identifier between said at least one user terminal and each of said plurality of Web servers, determining whether a valid client identifier is affixed to the target data in said proxy server, and abandoning the target data in a case where it is determined that there is no valid client identifier affixed to the target data;
(c) cumulatively storing billing data to be sent from each of said plurality of Web servers to said user terminal, of data to be relayed by said proxy server; and
(d) calculating an amount of money to be paid by said user to each of said plurality of Web servers in said settlement server, based on the stored billing data.

8. The online shopping method according to claim 7, further comprising
connecting said at least one user terminal to said Internet, and wherein
in said connecting, performing user authentication as to whether the user is a proper user, connecting said at least one user terminal to an access server in a case where it is determined the user is a proper user, and permitting said at least one user terminal to access said proxy server through said access server.

9. The online shopping method according to claim 7, further comprising
providing said at least one user terminal with personal information specifying the user, and wherein
said proxy server is connected to a database server which stores the personal information; and
in said providing, said proxy server detects a personal-information request which is sent from each of said plurality of Web servers to said at least one user terminal, acquiring personal information corresponding to the detected personal-information request from the stored personal information in said database server, and relays the personal information request with the acquired personal information affixed thereto to said at least one user terminal, so that said at least one user terminal can corrects the relayed personal information.

10. An online shopping system comprising:
a repeater which relays data between at least one user terminal and each of a plurality of Web servers;
an authentication server which stores authentication information for authenticating a user to connect to said repeater, determines whether the user is a proper user based on the stored authentication information, and authorizes said user of said at least one user terminal to access said plurality of Web servers via said repeater;
a memory device which cumulatively stores billing data sent from each of said plurality of Web servers to said at least one user terminal via said repeater, of data to be relayed by said repeater; and
a settlement server which calculates an amount of money to be paid by the user to each of said plurality of Web servers, based on the stored billing data, and acts as a collector for collecting the calculated amount of money from said at least one user terminal.

11. The online shopping system according to claim 10, further comprising
a proxy server which:
stores personal information of the user of said at least one user terminal to be connected to said repeater;
in response to a personal-information request sent from each of said plurality of Web servers to said at least one user terminal, reads out requested personal information included in the stored personal information; and
relays the personal-information request with the read personal information affixed thereto, to said at least one user terminal through said repeater.

12. The online shopping system according to claim 11, wherein:
said authentication server generates a client identifier for identifying said at least one user terminal, and temporarily assigns said user terminal the generated client identifier which is valid until said at least one user terminal completes connecting to said repeater; and
in a case where target data is relayed with the client identifier between said at least one user terminal and each of said plurality of Web servers, said proxy server determines whether a valid client identifier is affixed to the target data to be relayed, and abandons the target data in a case where it is determined that there is no valid client identifier affixed thereto.

13. The online shopping system according to claim 12, wherein said client identifier includes an IP address of said at least one user terminal and time information representing time user authentication of the user is performed.

14. A computer program product comprising a computer readable recording medium having program codes embodied in said medium, said program codes including:
a first program code for controlling a computer to act as a repeater which relays data between at least one user terminal and a plurality of Web servers;
a second program code for controlling a computer to act as an authentication unit which stores authentication information for authenticating a user to connect to said repeater, determines whether the user is a proper user based on the stored authentication information, and authorizes said user of said at least one user terminal to access said plurality of Web servers via said repeater;
a third program code for controlling a computer to act as a history recorder which cumulatively stores billing data sent from said plurality of Web servers to said at least one user terminal, of data to be relayed via said repeater; and
a fourth program code for controlling a computer to act as a settlement unit which calculates an amount of money to be paid by the user to each of said plurality of Web servers, based on the stored billing data, and as a collector which collects the calculated amount of money from the user.

15. The computer program product according to claim 14, wherein said program codes further include
a fifth computer code for controlling a computer to act as a personal-information responding unit which:
stores personal information of the user to be accessing said repeater;
in response to a request for personal information from said plurality of Web servers, acquires personal information corresponding to the request from the stored personal information; and
relays the request together with the read personal information affixed thereto, to said at least one user terminal via said repeater.

16. The computer program product according to claim 14, wherein said program codes further include:
a sixth program code for controlling a computer to act as a client-identifier setting unit which generates a client identifier for identifying said at least one user terminal, and temporarily assigning said at least one user terminal said client identifier which is valid until said at least one user terminal completes connecting to said repeater; and
a seventh program code for controlling a computer to determine whether a valid client identifier is affixed to target data to be relayed, in a case where the target is relayed between said at least one user terminal and said plurality of Web servers together with the client identifier via said repeater, and to abandon the target data in a case where it is determined that there is no valid client identifier affixed thereto.

17. The computer program product according to claim 16, wherein
the client identifier includes an IP address of said at least one user terminal and time information representing time user authentication of the user is performed.
